(19) United States
(12) Patent Application Publication
(10) Pub. No.: US 2026/0017526 A1
(43) Pub. Date: Jan. 15, 2026

(54) Speed Up Methods and Systems for Large Language Model Training

(71) Applicant: Applications Technology (AppTek), LLC, McLean, VA (US)

(72) Inventors: Yingbo Gao, Aachen (DE); David Thulke, Aachen (DE); Zijian Yang, Aachen (DE); Jintao Jiang, Great Falls, VA (US); Mudar Yaghi, McLean, VA (US)

(21) Appl. No.: 19/266,658

(22) Filed: Jul. 11, 2025

Related U.S. Application Data
(60) Provisional application No. 63/670,095, filed on Jul. 11, 2024.

(51) Int. Cl. G06N 3/09; G06N 3/0475

(52) U.S. Cl. CPC G06N 3/09; G06N 3/0475

(57) ABSTRACT

A method initializes and accelerates training of neural network based large language model, including by: (i) accessing a corpora for training a neural-network based large language model having word embeddings and word projections in respective word embedding and word projection layers and at least one hidden layer; (ii) counting raw token frequencies associated with content within the corpora; (iii) smoothing the raw token frequencies into a series of vector norms based on log or scaled log functions parameterized by maximum norm information; and (iv) injecting vector norm information into word embeddings and/or word projections based on norm-angle reparameterization to prepare the large language model for training.

### CROSS REFERENCE TO RELATED APPLICATIONS

This application claims priority to U.S. Provisional Patent Application No. 63/670,095, filed on Jul. 11, 2024, entitled, “Speed-Up Methods And Systems For Large Language Model Training,” the entirety of which is incorporated herein by reference.

### FIELD OF THE INVENTION

The present invention relates generally to large language models (LLMs) that may be used in machine learning, natural language processing, computational linguistics and artificial intelligence and, more specifically, to techniques for accelerating training of large language models by increasing convergence speed and traverse time.

### BACKGROUND OF THE INVENTION

Large language models (LLMs) are artificial neural networks that are trained on huge corpora of human language text, which belong to the broader domains of machine learning, computational linguistics, natural language processing and artificial intelligence. They can understand, generate and manipulate human language.

LLMs have exhibited strong capabilities and are improving at a fast rate. In the last decade, neural-network-based LLMs have improved drastically. This is evident from two aspects of LLM implementation: data and modeling. Regarding data, the training corpora size went from several hundred thousand sentences to billions of documents. If one considers the token (a “token” is an atomic unit of corpora presented to the neural network) count, it also went from millions to hundreds of trillions. Regarding modeling, the state-of-the-art model architecture evolved from simple feedforward networks to recurrent networks, and to self-attention-based networks. At the same time, the parameter counts of such networks also grew dramatically, from millions to hundreds of billions.

Large language models are trained on huge human language corpora. At present, the training corpora can encompass up to dozens of trillions of tokens. They are also diversified, containing text data crawled from the web, source code, mathematical reasoning, scientific text, medical text, law text, etc. Consequently, the typical training loop of large language models today are often compromised, going from being able to traverse the data several times (“epochs”), to simply traversing the entire corpora once.

In terms of both time and cost, it is very expensive to train large language models. To learn an effective model of hundreds of billions of free parameters is not easy. And it is increasingly costly when bigger and bigger models are trained on larger and larger quantities of data. Despite efficient attention computation kernels being introduced, and complicated parallelization techniques being adopted, the successful training of large language models can still take months and cost millions of dollars even with efficient computation clusters with hundreds of GPUs.

Although it is possible to initialize custom models with publicly available pretrained models and finetune them, potential large adaptation needs still call for efficient training methods. One may argue that the large cost associated with large language model training is a one-time-cost, and one can start building custom models from publicly available pretrained foundational models. Beyond the obvious licensing risks as well as further constraints on modeling and training, the large potential adaptation needs still make it imperative to have efficient training methods. Consider a potential large-language-model-based application that is customizable for millions of users, it is unrealistic to fully rely on existing adaptation methods as one current training pipeline multiplied by a factor of millions is too costly even for the biggest companies.

In view of the foregoing, there is a need to make the training of large language models more efficient in terms of time and required computational resources. There is a further need to identify sources of delay in the LLM training process and develop methods to address those delays to make the process more time and resource efficient. There is a further need to identify techniques to address delay in initialization and convergence of models. There is a further need to go beyond random sampling from pre-determined uniform or Gaussian distributions used to initialize LLM word vectors which, while simple, lacks efficiency.

There is still a further need to address delays associated with traversing massive amounts of data reflected in corpora and batched training pipelines. When each document in a corpora is treated as a separate unit, because of limited GPU memory and computational efficiency, one often needs to reduce the total training epoch down to 1 in order to accommodate the vast amount of data, which reduces accuracy.

### SUMMARY OF THE INVENTION

According to an embodiment of the present invention, systems and methods of training LLMs incorporate one or both of two processes for accelerating and making training more efficient. According to one, a process for initialization of model parameters is provided that gives an initial boost in model convergence. According to another, a process of batching and processing batched documents from the corpora is altered to lower the overall cost of training. The two methods are orthogonal in nature and can be applied jointly.

Consider a state-of-the-art large language model, which is comprised of an embedding layer, a stack of self-attentional hidden layers, and a final projection layer. The first method stems from the observation that a converged model tends to learn word vectors such that the vector norms are in proportion to the empirical frequencies of the words (tokens in actual implementations). According to an embodiment of the invention, a method of training models makes use of this observation, pre-counts word frequencies before training and initializes word vectors such that: vector norms are in proportion to the empirical word frequencies and the vector directions are random. Compared to current word embedding initialization techniques that sample randomly from predefined distributions, the disclosed approach additionally considers the easy-to-get counting information to help the initialization process. Count-motivated initialization will aid the convergence process and introduces no more overhead once the initialization is done.

This method may also incorporate sharing weight matrices between the word embedding and the final projection layer, and in such a case, the same word vector initialization may be applied to the final projection matrix as well. Because word embeddings are typically parametrized as unconstrained, continuous-valued vectors, specifying the maximum norm among all words (tokens) may be implemented. The vector initialization process is also referred to herein as vector norm-angle reparameterization.

To enable more efficient traversal over the training corpora, it is necessary to first briefly describe the existing training logic. Documents from the training corpora may be batched, optionally bucketed by length, optionally concatenated or padded to equal lengths, and fed to the neural network batch after batch. For each batch, a forward pass is done to calculate the current model predictions against the golden truth using some performance metrics. The typical task formulation is given all previous context tokens (for a language that reads from left-to-right, it would be all tokens to the left of the token under consideration), what is the probability of the current token. The typical training criterion is cross-entropy, which can be thought of as a measure of information loss transmitting the current token over a noisy channel (the neural network). Next, a backward pass is done, where the partial derivative (gradient) of each free model parameter is calculated. It is further optional to accumulate the gradients over many batches to simulate a larger batch size. A gradient optimization step is then performed, where each free model parameter moves a little (controlled by learning rate) according to the direction given by the gradient. This procedure is repeated until convergence, until a certain number of epochs or until a specified number of iterations.

The second disclosed method deals with how documents are batched together. In the approach described above, each sample document occupies one row in the batch size by maximum length input matrix. While implementing concatenation within a row may reduce some redundancies in padding, it is not ideal for accelerating or making training more efficient for two main reasons. First, modern language models rely heavily on effectively mixing context to predict the next word and the calculation of which is quadratic in sentence length for the state-of-the-art self-attention models. Concatenation will increase total input length and thus negatively impact the processing time. Second, when two unrelated sentences are concatenated together along the time axis, it is important to carefully adjust the attention mask matrix such that attention does not happen across sentence boundaries. This is extra effort in implementation.

At the same time, allocating a single row to each document is a potential point of inefficiency because if there are enough redundancies in the hidden dimension of word vectors, one can represent more than one document using the same vector. Therefore, the disclosed method squeezes multiple documents into one row of the input matrix, effectively enlarging the batch size by the same factor. The squeeze operation can be implemented via the addition operation in the vector space, and any other mathematical operations that can achieve the same goal of converting multiple vectors into one vector are applicable, e.g. a pooling operation.

Compared to concatenation, the disclosed method is better in the sense that it exploits inherent redundancies in the hidden space. That is, we conject that having standalone sentences along the batch dimension, where each sentence is represented by the entire word vector, may be a waste in the model parameters, meaning that we could potentially represent more information with a fixed number of parameters. The disclosed method therefore focuses on condensing sentences along the batch dimension, instead of simply concatenating them. In this way, the total sentence length is not increased, but the information is more densely represented in each batch.

Because with the method each row along the batch dimension is no longer physically referring to one sample document but multiple documents, according to an embodiment of the invention, the loss calculation is adapted. Specifically, instead of calculating the cross-entropy loss against one golden truth, the raw model output logits are compared against each of the golden truths of the original documents. Using the same analogy as before, instead of measuring the loss of transmitting one message over the noisy channel, multiple messages are transmitted through the same channel (the neural network). The transmitted message is then decoupled via the projection layer and decoded into different messages, which are to be compared against the original messages.

A method according to an embodiment of the invention for initializing and accelerating convergence during training of a neural network based large language model includes: (i) accessing a corpora for training a neural-network based large language model having word embeddings and word projections in respective word embedding and word projection layers and at least one hidden layer; (ii) counting raw token frequencies associated with content within the corpora; (iii) smoothing the raw token frequencies into a series of vector norms; and (iv) injecting vector norm information into word embeddings based on norm-angle reparameterization to prepare the large language model for training.

The method may further include injecting vector norm information into word projections based on norm-angle reparameterization to prepare the large language model for training and performing training on the large language model based on the updated word embeddings and word projections. The smoothing may be performed based on a log function or a scaled logarithmic function parameterized by maximum norm information.

A system for initializing and accelerating convergence during training of a neural network based large language model according to an embodiment of the present invention comprises a database, memory and at least one GPU. The database includes a corpora for training. The memory includes a neural-network-based large language model, program instructions for training the large language model and program instructions for initializing at least one of word embeddings and word projections. The at least one GPU is coupled to the database and the memory, and executes the program instructions to cause the initialization and training of the large language, wherein the at least one GPU: (i) accesses a corpora for training a neural-network based large language model having word embeddings and word projections in respective word embedding and word projection layers and at least one hidden layer, (ii) counts raw token frequencies associated with content within the corpora, (iii) smooths the raw token frequencies into a series of vector norms, and (iv) injects vector norm information into word embeddings based on norm-angle reparameterization to prepare the large language model for training.

According to still another embodiment of the invention, a condensed batching method to accelerate neural-network training, comprises: (i) accessing a corpora for training a neural-network-based large language model that includes a plurality of documents; (ii) processing the documents to condense at least two documents into each batch used to train the large language model; (iii) comparing the condensed documents against multiple golden truth documents to obtain performance metrics for gradient optimization; (iv) performing gradient optimization to train the large language model; and (v) repeating the comparing and performing steps to train the large language model. The processing to condense may be performed using vector addition or pooling operations.

According to another embodiment of the invention, a method for accelerating training of a large language model includes an initialization method and a batching method. The initialization method includes (i) accessing a corpora for training a neural-network based large language model having word embeddings and word projections in respective word embedding and word projection layers and at least one hidden layer; (ii) counting raw token frequencies associated with content within the corpora; (iii) smoothing the raw token frequencies into a series of vector norms; and (iv) injecting vector norm information into word embeddings based on norm-angle reparameterization to prepare the large language model for training. The batching method, includes: (i) accessing the corpora and its associated plurality of documents; (ii) processing the documents to condense at least two documents into each batch used to train the large language model; (iii) comparing the condensed documents against multiple golden truth documents to obtain performance metrics for gradient optimization; (iv) performing gradient optimization to train the large language model; and (v) repeating the comparing and performing steps to train the large language model.

### BRIEF DESCRIPTION OF THE FIGURES

The above described features and advantages will be more fully appreciated with reference to the Figures below and the Detailed Description.

FIG. 1 depicts an illustrative block diagram of layers of a large neural network based language model.

FIG. 2 depicts a typical histogram of counting raw word frequencies from a training corpora used to train a large neural network based language model.

FIG. 3 depicts an illustrative histogram after a smoothing function is applied.

FIG. 4 depicts an illustrative view of word vectors before and after an initialization method according to an embodiment is applied.

FIG. 5 depicts an illustrative view of some embodiments where word vector initialization may be applied.

FIG. 6 depicts an illustrative, efficient batching method according to an embodiment of the invention.

FIG. 7 depicts a procedure to calculate a local loss at a certain time step.

FIG. 8 depicts a procedure to calculate a local loss at a certain time step when condensation according to an embodiment of the invention is applied.

FIG. 9 depicts a training setup with a focus on components of batching, embedding initialization, and loss calculation.

FIG. 10 depicts an illustrative view of a more efficient training pipeline for large language models, according to an embodiment of the invention.

FIG. 11 depicts an illustrative system that may be used to train more efficiently a large language model according to an embodiment of the present invention.

### DETAILED DESCRIPTION

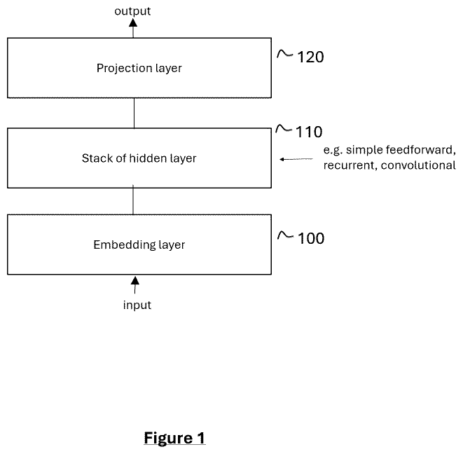

The disclosed methods address how large neural network language models can be trained efficiently. Consider a large neural-network-based language model made up of an embedding layer, a stack of hidden layers, and a final projection layer, as illustrated in FIG. 1. The embedding matrix and the projection matrix can be optionally shared because they have the same dimensions.

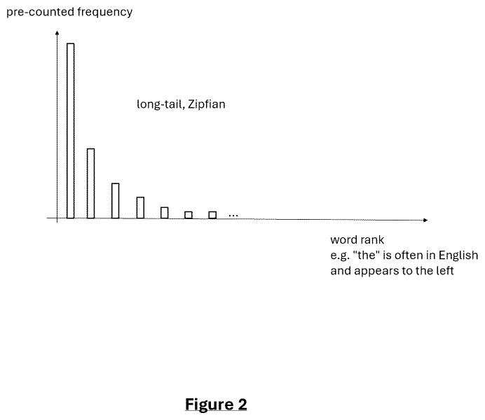

One first goes over predefined training corpora to collect token frequency statistics. For typical natural language corpora, if one plots the raw counts against the token frequency ranks, the empirical frequencies often follow a long-tailed curve, sometimes referred to as a Zipfian distribution, see FIG. 2.

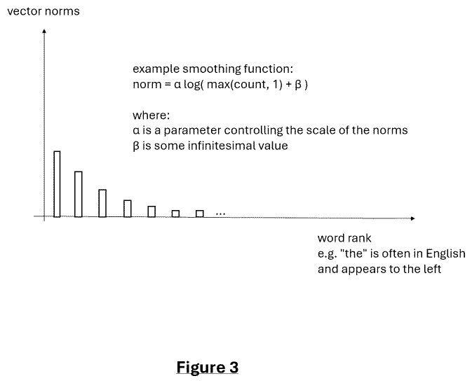

With the pre-counted frequency statistics, one may apply a smoothing function of the raw counts and convert a series of counts into a series of vector norms, see FIG. 3. One example of such functions is a scaled log function parametrized by the maximum norm.

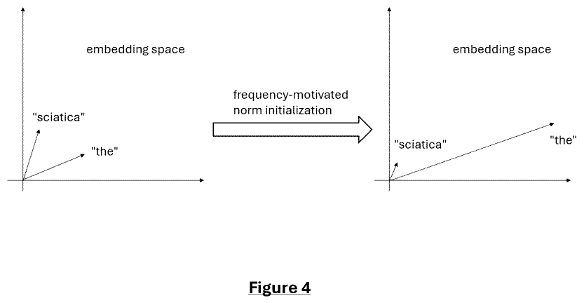

Given the series of vector norms, one first initializes the word embedding matrix randomly, an example of which can be simply sampling from the uniform distribution. Then this randomly initialized matrix is reparametrized into a series of vector norms and a matrix of vector directions. The final step is to replace the original series of vector norms with the pre-counted and pre-smoothed vector norm series. This way, the empirical count information is injected into the model parameter initialization and gives an initial boost when the actual training starts. This procedure is illustrated in FIG. 4.

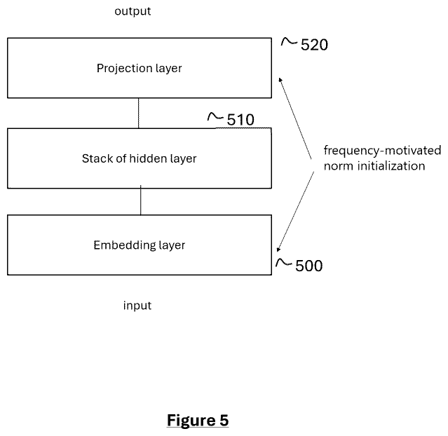

Optionally, one can share (or tie) the embedding matrix and the projection matrix. When it is the case, the same procedure described in the last paragraph is applied to the projection matrix, see FIG. 5.

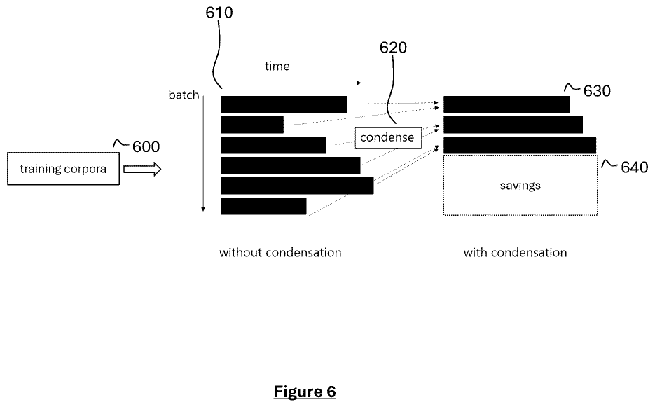

Large language models are trained on samples from large, prepared corpora. Examples are sampled, batched, optionally bucketed and padded to form the input matrix to the neural network. FIG. 6 first depicts the input matrix in a padded and no document concatenation setup. Each row contains one sample document. Although it is also possible to concatenate multiple documents along the time dimension, there is no further condensation along the batch dimension. In a condensed setup, multiple rows from the previous setups are further condensed into one row via some mathematical operation, the most simplistic of which is a summation of the word vectors, therefore yielding savings. The savings can then be exploited via filling more document samples into the batch or reducing the batch size to use smaller memory during training. The former has the benefit of reducing the total number of batches which in turn reduces the total training time. The latter has the benefit of reducing hardware cost by allowing lower-end GPUs.

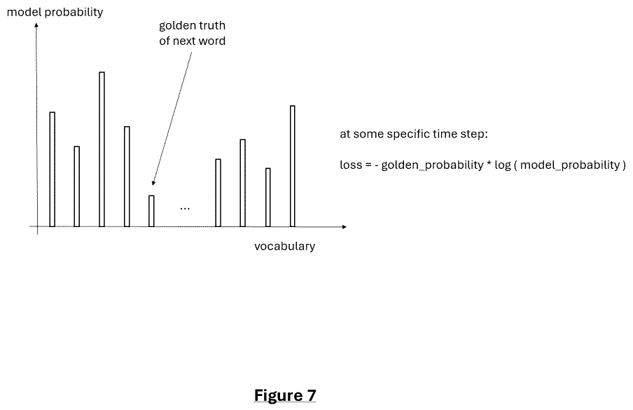

The improvements from condensing multiple sentences are not unlimited. Consider the extreme case where all sentences in the training corpus are condensed into one single sample forming a single batch. Because the information density is too high in such a batch, it will be extremely difficult for the model to effectively learn from this sample, and although significant speedups can be achieved (only one optimization step required to go over the entire corpus), significant losses in model performance are also implied. Therefore, there is a theoretical limit to how much time or resource savings (including memory savings) can be realized during training before performance compromises have to be made. Empirically, condensing more than two sentences into one sample already brings a noticeable degradation. Notice that for a typical autoregressive language modeling setup, the gold truth document is shifted by one position along the time dimension to simulate the task of “given previous words, predict the next word”. On the output side, the model probability outputs are checked against the gold truth probability, for which one for the correct next word and zero for other words in the vocabulary are typically used. FIG. 7 illustrates this loss calculation at some certain time step using cross-entropy and plugging in the golden probability definition above.

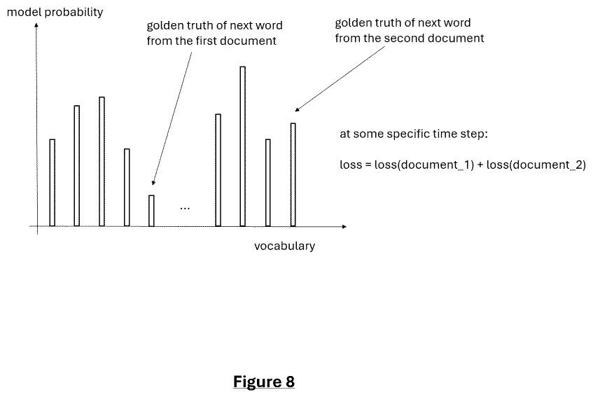

When multiple documents are condensed during batching, it is necessary to recover the loss for each contributing document. This can be done by applying the loss described in the last paragraph several times. In FIG. 8, an example is given for the case when two documents are condensed together.

With the empirical-frequency-motivated initialization, the model training is boosted with prior knowledge. With the condensed input and output formulation and the assumption that there is enough redundancy in the hidden representations, the traversal over the training corpora becomes faster because each pair of input and output contains more examples.

FIG. 1 illustrates a large neural-network-based language model. The architecture can be separated into three parts, an embedding layer 100, a stack of hidden layers 110, and a final projection layer 120. The input to such a model is a batch size by sequence length matrix, the values of which are integers denoting the indices of the tokens in some pre-defined vocabulary table. The hidden layers can be simple feedforward layers, recurrent layers, convolutional layers and self-attentative layers, whose purpose is to mix the tokens in context to form a descriptive context vector. The projection layer is a dense matrix (whose weights can be shared with the embedding layer) projecting the context vector into the vocabulary size, and a softmax operation is further performed to convert the quantities into probabilities. Some details such as positional encoding and residual connections are omitted in this illustration for simplicity but are understood by those having ordinary skill in the art.

FIG. 2 illustrates a typical histogram of counting raw frequencies from the training corpora. The characteristic of the histogram is that it is long tailed, often referred to as Zipfian, when one orders the bins (corresponding to the words) in the decreasing order of the frequency ranks.

FIG. 3 illustrates the smoothed series of word vector norms after applying some smoothing function. One example smoothing function that is log-shaped is given. Under this specific smoothing function, the resulting series of word vector norms retain the original relative order, but the absolute frequency values are mapped to word vector norms, which are later injected into the model initialization.

FIG. 4 illustrates the word vectors before and after the initialization method. In this example, before applying the initialization method, in the hidden space, the word vectors point to random directions and have random vector norms. After applying the initialization method, the directional initializations are retained, but the word vector norms are changed according to the smoothed values of the empirical frequency statistics.

FIG. 5 illustrates where the word vector initialization can be applied. Specifically, it is applicable to both the word embedding layer 500 and the final projection layer 520. When weight tying is activated, the vector norm initializations can be shared. When it is not activated, the vector norm initialization method can be applied separately to both initializations.

FIG. 6 illustrates the efficient batching method. When document samples are retrieved from the training corpora 600, instead of letting each document occupy an entire row 610 in the batch size by time steps matrix, multiple documents are condensed into one condensed row 630. In the figure, the condensation factor is two, meaning every two documents are condensed into one row, yielding savings 640 that is half of the size of the original matrix. It is either possible to further fill the savings part with more documents, or simply reduce the batch size by half. The former approach means faster traversal over the training corpora, while the latter indicates lower memory consumption during training. The specific mathematical operation for condensation can be versatile, for example, a simple addition in the hidden space is possible, or alternatively, any other operations that map multiple vectors to one can be used, e.g. pooling. With regard to the choice of the mathematical operation for condensing sentences, although simple operations like addition and pooling satisfy the requirements on the surface, more complex operations may be implemented. This is because of the inherent complexity in natural language text or sequences alike (e.g. code).

Modern methods rely heavily on inner product operations among word vectors to determine their (dis) similarities and subsequently probabilities. Simply adding up or pooling word vectors from different sentences may cause noticeable or significant loss of information in the latent representations. Therefore, alternative and potentially nonlinear operations may be implemented to reduce this information loss. One way to look at the problem is to think of it as a dimensionality reduction problem when concatenating two D-dimensional word vectors and needing to bring down the dimension from 2D back to D. The Johnson-Lindenstrauss lemma states that it is possible obtain low-distortion D-dimensional embeddings with random orthogonal projection. In practice, one extension is to introduce a dedicated neural network component that does the dimensionality reduction in a non-linear manner. Because word vectors from natural languages are not standalone—they reside in sequences—it is further possible to consider the dimensionality reduction of the two documents on the sequence level. To this end, more complex operations such as the attention mechanism can be applied. One example is provided below.

Example (assuming a hidden dimension of 2 and omitting special tokens such as beginning-of-document and end-of-document):
Document 1 “I like reading <pad><pad>” is represented as [1,2], [2, −1], [3, 3], [0, 0], [0,0]].
Document 2 “Chocolate is poisonous to dogs” is represented as [2, 5], [1, −2], [−4, −3], [−1, −1], [1, 3]].

An equal-weight element-wise addition is performed on document 1 and 2 to create a condensed representation that forms a single batched row: [[3, 7], [3, −3], [−1, 0], [−1, −1], [1, 3]].

This way, we condense the otherwise 2×5×2 (batch size by time steps by hidden dimension) stacked tensor to a 1×5×2 compact tensor.

Notice how our procedure is different to a simple concatenation along the time dimension which will result in a (5+5)×2 tensor, and how we effectively achieve higher information density by exploiting the potential redundancies in the hidden space.

FIG. 7 illustrates a procedure to calculate a local loss at a certain time step. This process involves obtaining the raw model output distribution over the vocabulary, plugging in a one-hot gold truth distribution (one at correct next word and zero elsewhere), and calculating the cross entropy. This process is common and straightforward for the no condensation case.

FIG. 8 illustrates the procedure to calculate a local loss at a certain time step when condensation is used. Because now the raw model output distribution contains contextual information for the next word for each contributing document, one needs to calculate the abovementioned loss against each of the golden truth one-hot distribution and sum up the contributing losses. This way, during training, the model is taught to predict the next words of each of the contribution document in one go.

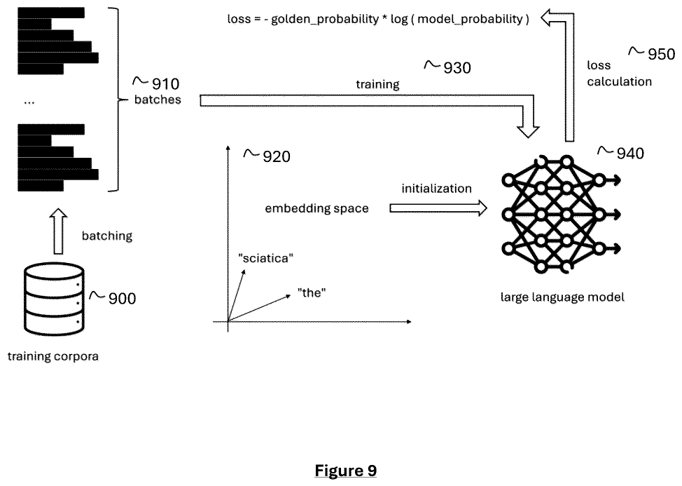

In FIG. 9, a traditional training setup with a focus on the components of batching, embedding initialization, and correspondingly loss calculation is illustratively shown. The documents from a training corpora 900 are first batched with each document taking up an entire row in a batch matrix 910, fed to the large language model 940. At the model side, the word embeddings 920 are initialized randomly by sampling from some predefined distribution. Regarding loss calculation 950, because single documents are separate along the batch dimension, simple cross entropy is applied.

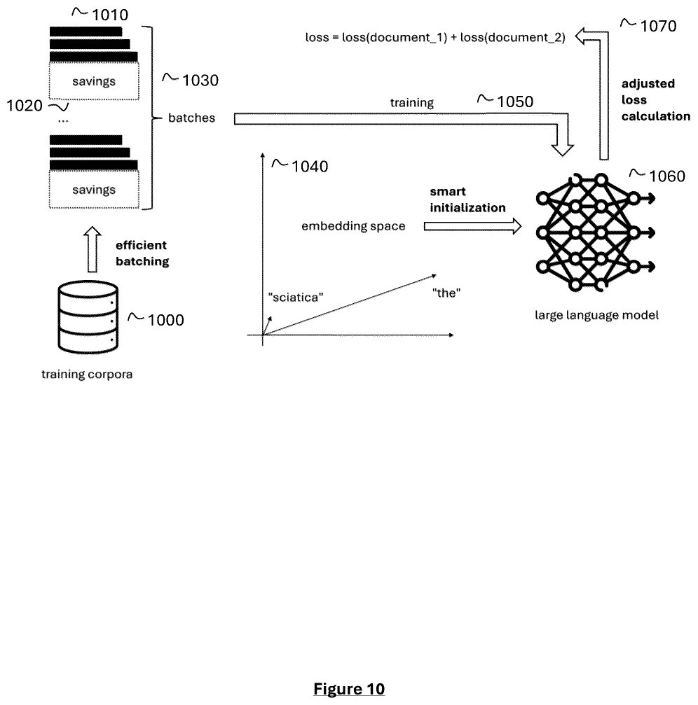

In FIG. 10, according to an embodiment of the present invention, a more efficient training pipeline for large language models is shown. At the batching side, efficient batching is implemented.

The batching results in memory savings during training (by condensing multiple documents into the same row in the batch matrix) or training speedups (by maintaining the same batch size but increasing the number of documents represented in the same batch). At the initialization side, word-count-motivated initialization is adopted, allowing for an initial boost of model convergence. Because now multiple golden truths are represented in each batch, loss calculation needs to be adjusted accordingly. Specifically, the model output is compared against each of the golden truth documents via cross entropy, and the total loss is accumulated over the documents.

More concretely, assume a training corpus 1000 comprised of N documents and we want to reduce the GPU memory usage by half during training (alternatively, we can require a fixed batch size that fully saturates the memory of a higher-end GPU but faster traversal over the training corpus, here for simplicity, we assume the case where we aim for memory reduction instead of training time reduction). We iteratively sample B documents from the training corpus 1000. We group the B documents in pairs 1010, 1020 and perform element-wise addition between each pair to effectively arrive at a condensed batch of size B/2 (larger memory reduction is possible with potential losses in modeling accuracy, here we assume a factor of 2). These batches 1030 are then fed to a neural language model 1060 whose word vector norms 040 are initialized in proportion to the empirical count frequency of the tokens. The usual forward-backward training framework of neural networks stays largely intact, with at least one core modification to the loss calculation 1070, according to one embodiment of the invention. Given the B/2×T×D context vector, where T is the time dimension and D is the hidden dimension, in some embodiments a goal is to recover the original B documents when calculating the cross-entropy loss. In order to do so, we first perform the usual logit projection into B/2×T×V, and then gather twice along the vocabulary dimension V, once with the first group of documents and once with the second group of documents used originally during batching. This way, a B×T tensor is recovered and we can perform the cross entropy loss calculation.

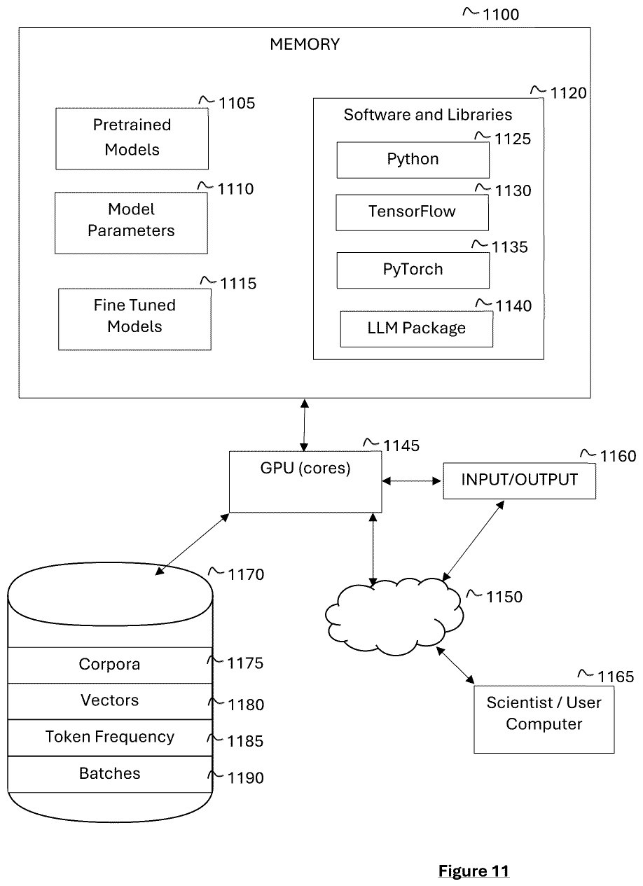

FIG. 11 depicts an illustrative system that may be used to train a large language model according to an embodiment of the present invention. Referring to FIG. 11, one or more GPU's 1145 each with multiple cores is coupled to a memory 1100, databases 1170, networks 1150, input/output devices 1160 and computers 1165 operated by data scientists training a large language model or users. The GPUs may be configured to specifically implement neural network based LLMs.

The memory includes large language models 1105 that may be custom created or pretrained. Each model may have associated parameters 1110 stored in memory. As a result of training, the fine tuned models 1115 may be created for one or more specific applications and stored in memory. The memory may also include software and libraries, such as Python 1125, TensorFlow 1130, Pytorch 1135 and one or more LLM packages 1140 for training or implementing specific large language models. Additional software may also be provided. In general, the software and libraries include program instructions that when executed by a processor or GPU cause the GPU and or System to take certain actions including training, initialization of word embeddings and word projections, batching of documents, compressing documents into batches, smoothing, calculation of loss, and other steps and processes described herein, including mapping frequency counts, injecting weights and other processes.

For training large language models, the GPU may be comprised of multiple GPU chips with hundreds, thousands or tens of thousands or cores, depending on the size. The memory may also range from several Gigabytes to tens or hundreds of Gigabytes. There is a trade-off between the processing power of the GPUs and size of the memory and the cost of the equipment and training endeavor and time to complete training. Techniques according to the present invention enable more efficient deployment of resources for training.

The input/output devices 1160 coupled to the GPUs may include keyboards, displays, speakers, microphones, and mouse devices to enable data scientists and users to interact with the large language models, software, and training tools associated with the system. The GPU may be implemented in a cloud-based environment where users interact with the GPU and associated memory via the cloud, the internet or networks. The database 1170 may store and provide to the system a variety of information including corpora 1175, vectors 1180, token (or word) frequencies 1185 and batches 1190 according to an embodiment of the present invention. Such information may also be available in memory or through network based storage and retrieval systems.

While particular implementations have been shown or described herein, it will be understood that changes may be made to those embodiments without departing from the spirit and scope of the present invention.

What is claimed is:

1. A method of initializing and accelerating convergence during training of a neural-network-based large language model, comprising:
accessing a corpora for training a neural-network based large language model having word embeddings and word projections in respective word embedding and word projection layers and at least one hidden layer;
counting raw token frequencies associated with content within the corpora;
smoothing the raw token frequencies into a series of vector norms; and
injecting vector norm information into word embeddings based on norm-angle reparameterization to create updated word embeddings and prepare the large language model for training.

2. The method according to claim 1, further comprising:
injecting vector norm information into word projections based on norm-angle reparameterization to create updated word projections and prepare the large language model for training.

3. The method according to claim 2, further comprising training the large language model based on the updated word embeddings and word projections.

4. The method according to claim 1, wherein the smoothing is performed based on a log function.

5. The method according to claim 1, wherein the smoothing is performed based on a scaled log function parametrized by maximum norm information.

6. A system for initializing and accelerating convergence during training of a neural network based large language model, comprising:
a database including a corpora for training;
a memory including a neural-network-based large language model, program instructions for training a large language model and program instructions for initializing at least one of word embeddings and word projections; and
at least one GPU, coupled to the database and the memory, the GPU executing the program instructions to cause the initialization and training of the large language, wherein the at least one GPU: (i) accesses a corpora for training a neural-network-based large language model having word embeddings and word projections in respective word embedding and word projection layers and at least one hidden layer, (ii) counts raw token frequencies associated with content within the corpora, (iii) smooths the raw token frequencies into a series of vector norms, and (iv) injects vector norm information into word embeddings based on norm-angle reparameterization to create updated word embeddings and to prepare the large language model for training.

7. The system according to claim 6, wherein the GPU further executes the program instructions to inject vector norm information into word projections based on norm-angle reparameterization to create updated word projections and to prepare the large language model for training.

8. The system according to claim 7, further comprising training the large language model based on the updated word and embeddings and word projections.

9. The system according to claim 6, wherein the smoothing is performed based on a log function.

10. The system according to claim 6, wherein the smoothing is performed based on a scaled log function parametrized by the maximum norm information.

11. A condensed batching method to accelerate neural network training, comprising:
accessing a corpora for training a neural-network based large language model that includes a plurality of documents;
processing the documents to condense at least two documents into each batch used to train the large language model;
comparing the condensed documents against multiple golden truth documents to obtain performance metrics for gradient optimization;
performing gradient optimization to train the large language model; and
repeating the comparing and performing steps to train the large language model.

12. The method according to claim 11, wherein the processing to condense is performed using vector addition.

13. The method according to claim 11, wherein the processing to condense is performed using pooling.

14. A method for accelerating training of a large language model, comprising:
an initialization method, including:
accessing a corpora for training a neural-network based large language model having word embeddings and word projections in respective word embedding and word projection layers and at least one hidden layer;
counting raw token frequencies associated with content within the corpora;
smoothing the raw token frequencies into a series of vector norms; and
injecting vector norm information into word embeddings based on norm-angle reparameterization to create updated word embeddings and to prepare the large language model for training; and
a batching method, including:
accessing the corpora and its associated plurality of documents;
processing the documents to condense at least two documents into each batch used to train the large language model;
comparing the condensed documents against multiple golden truth documents to obtain performance metrics for gradient optimization;
performing gradient optimization to train the large language model; and
repeating the comparing and performing steps to train the large language model.

15. The method according to claim 14, further comprising:
injecting vector norm information into word projections based on norm-angle reparameterization to create updated word projections and to prepare the large language model for training.

16. The method according to claim 15, further comprising training the large language model based on the updated word embeddings and word projections.

17. The method according to claim 15, wherein the smoothing is performed based on a log function.

18. The method according to claim 15, wherein the smoothing is performed based on a scaled log function parametrized by maximum norm information.

19. The method according to claim 15, wherein the processing to condense is performed using vector addition.

20. The method according to claim 15, wherein the processing to condense is performed using pooling.
